(19) United States
(12) Patent Application Publication
(10) Pub. No.: US 2009/0053419 A1
(43) Pub. Date: Feb. 26, 2009

(54) POLYMER SEALANT COMPOSITION AND METHOD OF USING SAME

(75) Inventors: David Ostroff, Cardiff, CA (US); David Bynon, Coronado, CA (US); Rick L. Vaal, Sarcasota, FL (US); Sam Lankford, Bradenton, FL (US)

Correspondence Address: DUCKOR SPRADLING METZGER & WYNNE;A LAW CORPORATION, 3043 4th Ave., SAN DIEGO, CA, 92103, US

(73) Assignee: Premium Finish Care, LLC

(21) Appl. No.: 11/845,011

(22) Filed: Aug. 24, 2007

(51) Int. Cl. B05D 3/02; C09K 3/00

(52) U.S. Cl. 427/372.2; 106/287.11

(57) ABSTRACT

The present invention relates in general to a finishing product composition and a method of using it. It more particularly relates to a finishing product composition that may be more easily applied to a surface while providing long lasting protection to that surface, and a method of using the finishing product composition.

### FIELD OF THE INVENTION

The present invention relates in general to a finishing product composition and a method of using it. It more particularly relates to a finishing product composition that may be more easily applied to a surface while providing long lasting protection to that surface, and a method of using the finishing product composition.

### BACKGROUND ART

This section describes the background of the disclosed embodiment of the present invention. There is no intention, either express or implied, that the background art discussed in this section legally constitutes prior art.

Commercial finishing products, such as waxes, polishes, and sealants are commonly used for protecting and enhancing the appearance of the surface of various objects, such as automobiles, furniture, counter tops, and other objects comprised of natural stone, stainless steel, glass, plastic, rubber, metal, paint, fiberglass, polymethyl methacrylate (such as Plexiglas®), polycarbonate (such as LEXAN®), fabric, aluminum, vinyl, or leather.

Although there are several commercial finishing products available, consumers are always looking for new and improved finishing products, which are easier to apply, while offering enhanced protection and appearance to the surfaces to which the finishing produce is applied.

### DESCRIPTION OF CERTAIN EMBODIMENTS OF THE INVENTION

As a preface to the detailed description, it should be noted that, as used in this specification and the appended claims, the singular forms “a”, “an”, and “the” include plural referents, unless the context clearly dictates otherwise.

When the term “about” is used herein, it is for purposes of indicating that the precision of the nominal value presented is ±10%.

It will be readily understood that the components of the embodiments as generally described herein, could be arranged and designed in a wide variety of different configurations. Thus, the following more detailed description of the embodiments of the finishing product and method of the present invention is not intended to limit the scope of the invention, as claimed, but is merely representative of the embodiments of the invention.

A finishing product and a method of using it to improve the protection and appearance of the surfaces to which it is applied according to certain embodiments of the invention may include amino functional siloxanes. According to certain embodiments of the invention, the finishing product may contain additional finishing product materials, such as volatile cyclic siloxanes, drying agents, organic solvent carriers, water, non-ionic surfactants, dyes, and fragrances in addition to the amino functional siloxanes.

A finishing product and method of using it to provide a fast, easy, and effective way to manage the appearance of various surfaces. The finishing product may be applied to a wide variety of surfaces, including, but not limited to, porous surfaces, non-porous surfaces, flexible surfaces, and non-flexible surfaces. The finishing product may simply be applied onto a surface by wiping or spraying. The finishing product may then be allowed to dry to a protective coating on the surface by evaporation without rubbing or buffing.

According to certain embodiments of the invention a method for treating a surface with a finishing product to create a protective coating upon the surface that enhances the appearance of the surface, comprising:
applying the finishing product to the surface, and
allowing the finishing product to dry to a solid protective coating by evaporation without rubbing or buffing,
   wherein the finishing product may include an amino functional siloxane, a drying agent, and a carrier agent.

An applicator may be used to apply the finishing product to the surface. The applicator may be a microfiber cloth, a microfiber sponge, a foam sponge, terry cloth, a disposable wet wipe, an aerosol spray can, a non-aerosol spray pump bottle, a combination thereof, or others.

According to certain embodiments of the method, the applicator may be a microfiber cloth. The microfiber cloth may have a length from about 12 inches to about 24 inches and a width of about 12 inches to about 24 inches. In other embodiments of the method, the applicator may be a microfiber cloth with a length of about 16 inches and a width of about 16 inches. In yet another embodiment of the invention the microfiber cloth may be in the form of a mitt or glove that may be worn on the hand of the user.

The microfiber cloth may be comprised of a hybrid fiber polyamide (nylon) and polyester blend, wherein the polyamide may make up the core of the hybrid fiber and the polyester may make up the outer skin of the hybrid fiber. The microfiber cloth may consist of about 20% to about 30% polyamide and about 70% to about 80% polyester. The microfiber cloth may include one or more of the following: a density of about 90,000 to about 225,000 fibers per square inch, microfibers with a weight of less than 0.1 denier, microfibers with a diameter of about 10 microns, and microfibers with splitting of the fibers to increase surface area.

In certain embodiments of the method, the applicator may be a foam block. The foam block may be partially or wholly covered with microfiber cloth. The foam block may have a length from about 5 inches to about 10 inches, a width of about 2 inches to about 5 inches, and a thickness of about 1 inch to about 3 inches. In other embodiments of the method, the applicator may be a foam block with a length of about 6 inches, a width of about 3.75 inches, and a thickness of about 2 inches.

According to certain embodiments of the method, the finishing product may include an amino functional siloxane. The amino functional siloxane may be comprised of amino-alkoxy dimethylsiloxane, aminoalkoxydimethylpolysiloxane, a combination thereof, or others.

In certain embodiments of the method, the finishing product may include from about 0.04% by weight to about 60% by weight of amino functional siloxane. In other embodiments, the finishing product may include from about 0.10% by weight to about 32% by weight of one or more amino functional siloxanes. Further embodiments may include from about 1% by weight to about 36% by weight of one or more amino functional siloxanes. In yet another embodiment, the finishing product may include from about 6% by weight to about 13% by weight of one or more amino functional siloxanes. In still other embodiments, the finishing product may include from about 8% by weight to about 60% by weight of one or more amino functional siloxanes. In further embodiments, the finishing product may include from about 18% by weight to about 32% by weight of one or more amino functional siloxanes. Other embodiments may include from about 0.9% by weight to about 26% by weight of one or more amino functional siloxanes. In yet another embodiment, the finishing product may include from about 4% by weight to about 7.5% by weight of one or more amino functional siloxanes. In still another embodiment, the finishing product may include from about 0.04% by weight to about 3% by weiqht of one or more amino functional siloxanes. In other embodiments, the finishing product may include from about 0.10% by weight to about 0.18% by weight of one or more amino functional siloxanes.

According to certain embodiments of the method, the finishing product may include a drying agent. The drying agent may be comprised of isopropyl alcohol, methyl alcohol, 1,2,4-trimethylbenzene, a combination thereof, or others.

In certain embodiments of the method, the finishing product may include from about 0.02% by weight to about 40% by weight of drying agent. In other embodiments, the finishing product may include from about 1.5% by weight to about 21% by weight of drying agent. In further embodiments, the finishing product may include from about 0.4% by weight to about 24% by weight of drying agent. In additional embodiments, the finishing product may include from about 2.5% by weight to about 8% by weight of drying agent. In other embodiments, the finishing product includes from about 3% by weight to about 40% by weight of drying agent. In yet another embodiment, the finishing product may include from about 7% by weight to about 21% by weight of drying agent. In one embodiment, the finishing product may include from about 0.35% by weight to about 17.5% by weight of drying agent. In another embodiment, the finishing product may include from about 1.5% by weight to about 5% by weight of drying agent. In yet another embodiment, the finishing product may include from about 0.02% by weight to about 3% by weight of drying agent. In other embodiments, the finishing product may include from about 2% by weight to about 3% by weight of drying agent.

According to certain embodiments of the method, the finishing product may include a carrier agent. The carrier agent may be comprised of water, organic solvent, a combination thereof, or others. The organic solvent may be comprised of petroleum distillate, Stoddard solvent, synthetic isoparafinic hydrocarbon, petroleum hydrocarbon, aliphatic hydrocarbon, 2,2-dimethylbutane, or a combination thereof. The non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others.

In certain embodiments of the method, the finishing product may include from about 0% by weight to about 0.5% by weight of a non-ionic surfactant. In other embodiments, the finishing product may include from about 0% by weight to about 0.3% by weight of a non-ionic surfactant. In yet another embodiment, the finishing product may include from about 0.11% by weight to about 0.5% by weight of a non-ionic surfactant.

According to another embodiment of the method, the finishing product may include from about 0% by weight to about 4.5% by weight of a volatile cyclic siloxane. In other embodiments, the finishing product may include from about 0% by weight to about 2.5% by weight of a volatile cyclic siloxane. In still another embodiment, the finishing product may include from about 0% by weight to about 2.6% by weight of a volatile cyclic siloxane. In other embodiments, the finishing product may include from about 0% by weight to about 0.86% by weight of a volatile cyclic siloxane. In yet another embodiments, the finishing product may include from about 0% by weight to about 4.4% by weight of a volatile cyclic siloxane. Other embodiments may include from about 0% by weight to about 2.3% by weight of a volatile cyclic siloxane. In another embodiment, the finishing product may include from about 0% by weight to about 1.9% by weight of a volatile cyclic siloxane. In yet another embodiment, the finishing product may include from about 0% by weight to about 0.55% by weight of a volatile cyclic siloxane. In other embodiments, the finishing product may include from about 0% by weight to about 0.025% by weight of a volatile cyclic siloxane. In still another embodiment, the finishing product may include from about 0% by weight to about 0.015% by weight of a volatile cyclic siloxane.

The volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others.

According to other embodiments of the method, the finishing product may further include from about 0% by weight to about 5% by weight of fragrance, and may include from about 0% by weight to about 5% by weight of dye.

According to one embodiment of the method, the finishing product may include:
about 0.04% by weight to about 60.5% by weight of an amino functional siloxane, wherein the amino functional siloxane may be comprised of amino-alkoxy dimethylsiloxane, aminoalkoxydimethylpolysiloxane, a combination thereof, or others;
about 0.02% by weight to about 40% by weight of a drying agent, wherein the drying agent may be comprised of isopropyl alcohol, methyl alcohol, 1,2,4-trimethylbenzene, a combination thereof, or others;
about 0% by weight to about 4.5% by weight of a volatile cyclic siloxane, wherein the volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others;
about 0% by weight to about 0.5% by weight of a non-ionic surfactant, wherein the non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others;
about 0% by weight to about 5% by weight of a fragrance;
about 0% by weight to about 5% by weight of a dye; and
a balance that may be selected from the group consisting of water, organic solvent carrier, or a combination thereof, wherein the organic solvent carrier may be comprised of petroleum distillate, Stoddard solvent, synthetic isoparafinic hydrocarbon, petroleum hydrocarbon, aliphatic hydrocarbon, 2,2-dimethylbutane, a combination thereof, or others.

According to another embodiment of the method, the finishing product may include:
about 0.1% by weight to about 32% by weight of an amino functional siloxane;
about 1.5% by weight to about 21% by weight of a drying agent;
about 0% by weight to about 2.5% by weight of a volatile cyclic siloxane;
about 0% by weight to about 0.3% by weight of a non-ionic surfactant;
about 0% by weight to about 5% by weight of a fragrance;
about 0% by weight to about 5% by weight of a dye; and
a balance that may be selected from the group consisting of water, organic solvent carrier, or a combination thereof.

According to another embodiment of the method, the finishing product may include:
about 1% by weight to about 36% by weight of an amino functional siloxane;
about 0.4% by weight to about 24% by weight of a drying agent;
about 0% by weight to about 2.6% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to a further embodiment of the method, the finishing product may include:
about 6% by weight to about 13% by weight of an amino functional siloxane;
about 2.5% by weight to about 8% by weight of a drying agent;
about 0% by weight to about 0.9% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to yet another embodiment of the method, the finishing product may include:
about 8% by weight to about 60.5% by weight of an amino functional siloxane;
about 3.2% by weight to about 40% by weight of a drying agent;
about 0% by weight to about 4.31% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

In a further embodiment of the method, the finishing product may include:
about 18% by weight to about 32% by weight of an amino functional siloxane;
about 7.2% by weight to about 21% by weight of a drying agent;
about 0% by weight to about 2.3% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to yet another embodiment of the method, the finishing product may include:
about 0.9% by weight to about 26.5% by weight of an amino functional siloxane;
about 0.3% by weight to about 18% by weight of a drying agent;
about 0% by weight to about 1.9% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to still another embodiment of the method, the finishing product may include:
about 4.2% by weight to about 7.5% by weight of an amino functional siloxane;
about 1.7% by weight to about 4.9% by weight of a drying agent;
about 0% by weight to about 0.6% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

In another embodiment of the method, the finishing product may include:
about 0.04% by weight to about 2.9% by weight of an amino functional siloxane;
about 0.02% by weight to about 2.8% by weight of a drying agent;
about 0% by weight to about 0.025% by weight of a volatile cyclic siloxane;
about 0.11% by weight to about 0.5% by weight of a non-ionic surfactant;
about 0% by weight to about 5% by weight of a fragrance;
about 0% by weight to about 5% by weight of a dye; and
a balance that may be selected from the group consisting of water, organic solvent carrier, or a combination thereof.

In further embodiments of the method, the finishing product may include:
about 0.1% by weight to about 0.2% by weight of an amino functional siloxane;
about 2.4% by weight to about 2.6% by weight of a drying agent;
about 0% by weight to about 0.015% by weight of a volatile cyclic siloxane;
about 0.2% by weight to about 0.3% by weight of a non-ionic surfactant;
about 0% by weight to about 5% by weight of a fragrance;
about 0% by weight to about 5% by weight of a dye; and
a balance that may be selected from the group consisting of water, organic solvent carrier, or a combination thereof.

According to certain embodiments of the invention, a finishing product for application to a surface to create a protective coating upon the surface that enhances the appearance of the surface without the need for buffing or rubbing the surface following application of the finishing product, wherein the finishing product comprises an amino functional siloxane, a drying agent, and a carrier agent.

The amino functional siloxane may be comprised of amino-alkoxy dimethylsiloxane, aminoalkoxydimethylpolysiloxane, a combination thereof, or others.

In certain embodiments of the invention, the finishing product may include from about 0.04% by weight to about 60% by weight of amino functional siloxane. In other embodiments of the invention, the finishing product may include from about 0.10% by weight to about 32% by weight of amino functional siloxane. In yet another embodiment of the invention, the finishing product may include from about 1% by weight to about 36% by weight of amino functional siloxane. In further embodiments of the invention, the finishing product may include from about 6% by weight to about 13% by weight of amino functional siloxane. In still further embodiments of the invention, the finishing product may include from about 8% by weight to about 60% by weight of amino functional siloxane. In another embodiment of the invention, the finishing product may include from about 18% by weight to about 32% by weight of amino functional siloxane. In additional embodiments of the invention, the finishing product may include from about 0.9% by weight to about 26% by weight of amino functional siloxane. In other embodiments of the invention, the finishing product may include from about 4% by weight to about 7.5% by weight of amino functional siloxane. In still other embodiments of the invention, the finishing product may include from about 0.04% by weight to about 3% by weight of amino functional siloxane. In yet another embodiment of the invention, the finishing product may include from about 0.10% by weight to about 0.18% by weight of amino functional siloxane.

According to certain embodiments of the invention, the drying agent may be comprised of isopropyl alcohol, methyl alcohol, 1,2,4-trimethylbenzene, a combination thereof, or others.

In certain embodiments of the invention, the finishing product may include from about 0.02% by weight to about 40% by weight of drying agent. In other embodiments, the finishing product may include from about 1.5% by weight to about 21% by weight of drying agent. In yet another embodiment, the finishing product may include from about 0.4% by weight to about 24% by weight of drying agent. In still other embodiments, the finishing product may include from about 2.5% by weight to about 8% by weight of drying agent. In further embodiments, the finishing product may include from about 3% by weight to about 40% by weight of drying agent. In other embodiments, the finishing product may include from about 7% by weight to about 21% by weight of drying agent. In yet another embodiment, the finishing product may include from about 0.35% by weight to about 17.5% by weight of drying agent. In still another embodiment, the finishing product may include from about 1.5% by weight to about 5% by weight of drying agent. In one embodiment, the finishing product may include from about 0.02% by weight to about 3% by weight of drying agent. In another embodiment, the finishing product may include from about 2% by weight to about 3% by weight of drying agent.

According to yet another embodiment of the invention, the finishing product may contain a carrier agent that may be comprised of water, organic solvent, a combination thereof, or others.

The organic solvent may be comprised of petroleum distillate, Stoddard solvent, synthetic isoparafinic hydrocarbon, petroleum hydrocarbon, aliphatic hydrocarbon, 2,2-dimethylbutane, a combination thereof, or others.

According to further embodiments of the invention, the finishing product may include from about 0% by weight to about 0.5% by weight of a non-ionic surfactant. In other embodiments, the finishing product may include from about 0% by weight to about 0.3% by weight of a non-ionic surfactant. In another embodiment, the finishing product may include from about 0.11% by weight to about 0.5% by weight of a non-ionic surfactant.

The non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others.

According to yet another embodiment of the invention, the finishing product may further include from about 0% by weight to about 4.5% by weight of a volatile cyclic siloxane. In other embodiments, the finishing product may include from about 0% by weight to about 2.5% by weight of a volatile cyclic siloxane. In another embodiment, the finishing product may include from about 0% by weight to about 2.6% by weight of a volatile cyclic siloxane. In yet another embodiment, the finishing product may include from about 0% by weight to about 0.86% by weight of a volatile cyclic siloxane. In further embodiments, the finishing product may include from about 0% by weight to about 4.4% by weight of a volatile cyclic siloxane. In other embodiments, the finishing product may include from about 0% by weight to about 2.3% by weight of a volatile cyclic siloxane. In another embodiment, the finishing product may include from about 0% by weight to about 1.9% by weight of a volatile cyclic siloxane. In still another embodiment, the finishing product may include from about 0% by weight to about 0.55% by weight of a volatile cyclic siloxane. In other embodiments, the finishing product may include from about 0% by weight to about 0.025% by weight of a volatile cyclic siloxane. In further embodiments, the finishing product may include from about 0% by weight to about 0.015% by weight of a volatile cyclic siloxane.

The volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others.

According to yet another embodiment of the invention, the composition further includes about 0% by weight to about 5% by weight of fragrance, and may include about 0% by weight to about 5% by weight of dye.

According to one embodiment of the invention, the finishing product may include:
about 0.04% by weight to about 60.5% by weight of an amino functional siloxane, wherein the amino functional siloxanes is comprised of amino-alkoxy dimethylsiloxane, aminoalkoxydimethylpolysiloxane, a combination
about 0.02% by weight to about 40% by weight of a drying agent, wherein the drying agent is comprised of isopropyl alcohol, methyl alcohol, 1,2,4-trimethylbenzene, a combination thereof, or others;
about 0% by weight to about 4.5% by weight of a volatile cyclic siloxane, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others;
about 0% by weight to about 0.5% by weight of a non-ionic surfactant, wherein the non-ionic surfactant is comprised of alkoxy polyethoxy ethanol, diethanolamine, coconut oil diethanolamide, acrylic polymer, nonylphenol ethoxylate, oleamide DEA, oleic acid, a combination thereof, or others;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, a combination thereof, or others.

According to another embodiment of the invention, the finishing product may include:
about 0.1% by weight to about 32% by weight of an amino functional siloxane;
about 1.5% by weight to about 21% by weight of a drying agent;
about 0% by weight to about 2.5% by weight of a volatile cyclic siloxane;
about 0% by weight to about 0.3% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

According to yet another embodiment of the invention, the finishing product may include:
about 1% by weight to about 36% by weight of an amino functional siloxane;
about 0.4% by weight to about 24% by weight of a drying agent;
about 0% by weight to about 2.6% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to still another embodiment of the invention, the finishing product may include:
about 6% by weight to about 13% by weight of an amino functional siloxane;
about 2.5% by weight to about 8% by weight of a drying agent;
about 0% by weight to about 0.9% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to yet another embodiment of the invention, the finishing product may include:
about 8% by weight to about 60.5% by weight of an amino functional siloxane;
about 3.2% by weight to about 40% by weight of a drying agent;
about 0% by weight to about 4.31% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to a further embodiment of the invention, the finishing product may include:
about 18% by weight to about 32% by weight of an amino functional siloxane;
about 7.2% by weight to about 21% by weight of a drying agent;
about 0% by weight to about 2.3% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to another embodiment of the invention, the finishing product may include:
about 0.9% by weight to about 26.5% by weight of an amino functional siloxane;
about 0.3% by weight to about 18% by weight of a drying agent;
about 0% by weight to about 1.9% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to another embodiment of the invention, the finishing product may include:
about 4.2% by weight to about 7.5% by weight of an amino functional siloxane;
about 1.7% by weight to about 4.9% by weight of a drying agent;
about 0% by weight to about 0.6% by weight of a volatile cyclic siloxane;
about 0% by weight of a non-ionic surfactant;
about 0% by weight to about 5% by weight of a fragrance;
about 0% by weight to about 5% by weight of a dye; and
a balance of organic solvent carrier.

According to yet another embodiment of the invention, the finishing product may include:
about 0.04% by weight to about 2.9% by weight of an amino functional siloxane;
about 0.02% by weight to about 2.8% by weight of a drying agent;
about 0% by weight to about 0.025% by weight of a volatile cyclic siloxane;
about 0.11% by weight to about 0.5% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

According to still another embodiment of the invention, the finishing product may include:
about 0.1% by weight to about 0.2% by weight of an amino functional siloxane;
about 2.4% by weight to about 2.6% by weight of a drying agent;
about 0% by weight to about 0.015% by weight of a volatile cyclic siloxane;
about 0.2% by weight to about 0.3% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

In the examples below, several embodiments of the invention are described. However, these examples are not intended to limit the scope of the invention.

### EXAMPLES

### Example One

A finishing product may be prepared by combining the following:
about 6.0% by weight to about 13% by weight of amino-alkoxy dimethylsiloxane;
about less than 0.17% by weight of methyl alcohol;
about 0.17% by weight to about 0.85% by weight of isopropyl alcohol;
about 2.5% by weight to about 6.8% by weight of 1,2,4-trimethylbenzene;
about less than 6% by weight of petroleum distillate;
about less than 6% by weight of Stoddard solvent;
about less than 5% by weight of fragrance; and
a balance of synthetic isoparaffinic hydrocarbon.

The finishing product may be applied to various surfaces, such as vinyl, leather, plastic, wood, aluminum, and fabric surfaces. The finishing product may be applied by spraying directly on the surface or may be wiped onto the surface using an applicator, such as a microfiber cloth or microfiber covered sponge. The finishing product does not require rubbing or buffing once on the surface, and may be allowed to dry by evaporation.

This finishing product may have the tactile effect of softening all leather and vinyl finishes, making them feel like fine cashmere. After the finishing product has dried upon a leather or vinyl surface, the leather or vinyl surface may have a slight sheen that is perfectly even and natural looking. When dry, the finishing product may effectively resist the negative effects of moisture, salt, body lotions, oil, and proteins upon a surface. Surfaces upon which the finishing product has been applied may later be easily cleaned by wiping down with a damp cloth. Surfaces may be treated twice a year to maintain the above described features.

### Example Two

A finishing product may be prepared by combining the following:
about 8.34 gallons of synthetic isoparaffinic hydrocarbon;
about 1.62 gallons of Dow Corning® 531 Fluid, from Dow Corning Corporation, of Midland Mich.; and
about 5 ounces of fragrance.

The finishing product may be applied to various surfaces, such as vinyl, leather, plastic, and fabric surfaces. The finishing product may be applied by spraying directly on the surface or may be wiped onto the surface using an applicator, such as a microfiber cloth or microfiber covered sponge. The finishing product does not require rubbing or buffing once on the surface, and may be allowed to dry by evaporation.

This finishing product may have the tactile effect of softening all leather and vinyl finishes, making them feel like fine cashmere. After the finishing product has dried upon a leather or vinyl surface, the leather or vinyl surface may have a slight sheen that is perfectly even and natural looking. When dry, the finishing product may effectively resist the negative effects of moisture, salt, body lotions, oil, and proteins upon a surface. Surfaces upon which the finishing product has been applied may later be easily cleaned by wiping down with a damp cloth. Surfaces may be treated twice a year to maintain the above described features.

### Example Three

A finishing product may be prepared by combining the following:
about 18.0% by weight to about 32% by weight of amino-alkoxy dimethylsiloxane;
about less than 0.45% by weight of methyl alcohol;
about 0.45% by weight to about 2.25% by weight of isopropyl alcohol;
about 6.75% by weight to about 18% by weight of 1,2,4-trimethylbenzene;
about less than 16% by weight of petroleum distillate;
about less than 16% by weight of Stoddard solvent;
about 4% by weight of petroleum hydrocarbon; and
a balance of synthetic isoparaffinic hydrocarbon.

The finishing product may be applied to various surfaces, such as rubber, chrome, polished aluminum, and plastic. The finishing product may be applied by spraying directly on the surface or may be wiped onto the surface using an applicator, such as a microfiber cloth or microfiber covered sponge. The finishing product does not require rubbing or buffing once on the surface, and may be allowed to dry by evaporation.

Surfaces treated with the finishing product may be protected months from pollution, ultra violet light, road salts, harmful ozone, and creosote. The coating of finishing product upon the surface will not easily wash off. On glossy surfaces it maintains the shine and prevents corrosion. On black trim it maintains a dark, satin appearance.

### Example Four

A finishing product may be prepared by combining the following:
about 5 gallons of synthetic isoparaffinic hydrocarbon;
about 80 fluid ounces of petroleum hydrocarbon; and
about 4.38 gallons of Dow Corning® 531 Fluid, from Dow Corning Corporation, of Midland Mich.

The finishing product may be applied to various surfaces, such as rubber, chrome, polished aluminum, and plastic. The finishing product may be applied by spraying directly on the surface or may be wiped onto the surface using an applicator, such as a microfiber cloth or microfiber covered sponge. The finishing product does not require rubbing or buffing once on the surface, and may be allowed to dry by evaporation.

Surfaces treated with the finishing product may be protected months from pollution, ultra violet light, road salts, harmful ozone, and creosote. The coating of finishing product upon the surface will not easily wash off. On glossy surfaces it maintains the shine and prevents corrosion. On black trim it maintains a dark, satin appearance.

### Example Five

A finishing product may be prepared by combining the following:
about 4% by weight to about 7.5% by weight of amino-alkoxy dimethylsiloxane;
about less than 0.015% by weight of methyl alcohol;
about 0.015% by weight to about 0.08% by weight of isopropyl alcohol;
about 0.2% by weight to about 0.6% by weight of 1,2,4-trimethylbenzene;
about less than 3.8% by weight of petroleum distillate;
about less than 3.8% by weight of Stoddard solvent;
about 16% by weight of petroleum hydrocarbon; and
a balance of synthetic isoparaffinic hydrocarbon.

The finishing product may be applied to various surfaces, such as painted surfaces. The finishing product may be applied by spraying directly on the painted surface or may be wiped onto the painted surface using an applicator, such as a microfiber cloth or microfiber covered sponge. The finishing product does not require rubbing or buffing once on the surface, and may be allowed to dry by evaporation.

Surfaces treated with the finishing product may result in a radiant shine and protection that will last for months. The finishing product provides long lasting, clear and easy paint protection that is resistant to detergents, pollution, hard water spotting, road salts, insect remains, bird droppings, and acid rain.

### Example Six

A finishing product may be prepared by combining the following:
about 7.35 gallons of synthetic isoparaffinic hydrocarbon;
about 1.63 gallons of petroleum hydrocarbon; and
about 1 gallon of Dow Corning® 531 Fluid, from Dow Corning Corporation, of Midland Mich.

The finishing product may be applied to various surfaces, such as painted surfaces. The finishing product may be applied spraying directly on the painted surface or may be wiped onto the painted surface using an applicator, such as a microfiber cloth or microfiber covered sponge. The finishing product does not require rubbing or buffing once on the surface, and may be allowed to dry by evaporation.

Surfaces treated with the finishing product may result in a radiant shine and protection that will last for months. The finishing product provides long lasting, clear and easy paint protection that is resistant to detergents, pollution, hard water spotting, road salts, insect remains, bird droppings, and acid rain.

### Example Seven

A finishing product may be prepared by combining the following:
about 0.1% by weight to about 0.2% by weight of amino-alkoxy dimethylsiloxane;
about less than 2.4% by weight of methyl alcohol;
about 0.0025% by weight to about 0.013% by weight of isopropyl alcohol;
about 0.039% by weight to about 0.1% by weight of 1,2,4-trimethylbenzene;
about less than 0.09% by weight of petroleum distillate;
about less than 0.09% by weight of Stoddard solvent;
about 0% by weight to about 0.013% by weight decamethylcyclopentasiloxane;
about 0.26% by weight of nonylphenol ethoxylate; and
a balance of Water.

The finishing product may be applied to various surfaces, such as paint, glass, plastic, chrome, vinyl, plastic, and leather. The finishing product may be applied by spraying directly on the surface or may be wiped onto the surface using an applicator, such as a microfiber cloth or microfiber covered sponge. The finishing product does not require rubbing or buffing once on the surface, and may be allowed to dry by evaporation.

Surfaces may be treated with the finishing product to clean, dust, and shine surfaces.

### Example Eight

A finishing product may be prepared by combining the following:
about 9.68 gallons of water;
about 28 fluid ounces of T-GUARD 450 from Taylor Chemical Company, Lawrenceville, Ga., or TEGO® Polish Additiv AE 30, from Degussa, supplied by Goldschmidt Chemical Corporation, Hopewell, Va.;
about 40 fluid ounces of methanol;
about 12 grams of dye; and
about 3 fluid ounces of fragrance.

The finishing product may be applied to various surfaces, such as paint, glass, plastic, chrome, vinyl, plastic, and leather. The finishing product may be applied by spraying directly on the surface or may be wiped onto the surface using an applicator, such as a microfiber cloth or microfiber covered sponge. The finishing product does not require rubbing or buffing once on the surface, and may be allowed to dry by evaporation.

Surfaces may be treated with the finishing product to clean, dust, and shine surfaces.

While particular embodiments of the present invention have been disclosed, it is to be understood that various different modifications are possible and are contemplated within the true spirit and scope of the appended claims.

What is claimed is:

1. A method for treating a surface with a finishing product to create a protective coating upon the surface that enhances the appearance of the surface, comprising:
applying the finishing product to the surface, and
allowing the finishing product to dry to a solid protective coating by evaporation without rubbing or buffing,
wherein the finishing product includes one or more amino functional siloxanes, a drying agent, and a carrier agent.

2. The method of claim 1, wherein an applicator is used to apply the finishing product to the surface and wherein the applicator is a microfiber cloth, a microfiber sponge, a foam sponge, terry cloth, a disposable wet wipe, aerosol spray can, a non-aerosol spray pump bottle, or a combination thereof.

3. The method of claim 1, wherein the one or more amino functional siloxanes is comprised of amino-alkoxy dimethylsiloxane, aminoalkoxydimethylpolysiloxane, or a combination thereof.

4. The method of claim 1, wherein the finishing product includes from about 0.04% by weight to about 60% by weight of one or more amino functional siloxanes.

5. The method of claim 1, wherein the drying agent is comprised of isopropyl alcohol, methyl alcohol, 1,2,4-trimethylbenzene, or a combination thereof.

6. The method of claim 1, wherein the finishing product includes from about 0.02% by weight to about 40% by weight of drying agent.

7. The method of claim 1, wherein the carrier agent is comprised of water, organic solvent, or a combination thereof.

8. The method of claim 7, wherein the organic solvent is comprised of petroleum distillate, Stoddard solvent, synthetic isoparafinic hydrocarbon, petroleum hydrocarbon, aliphatic hydrocarbon, 2,2-dimethylbutane, or a combination thereof.

9. The method of claim 1, wherein the finishing product further includes from about 0% by weight to about 0.5% by weight of a non-ionic surfactant.

10. The method of claim 9, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof.

11. The method of claim 1, wherein the finishing product further includes from about 0% by weight to about 4.5% by weight of a volatile cyclic siloxane.

12. The method of claim 11, wherein the volatile cyclic siloxane is comprised of dimethylcyclosiloxane, hexamethylcyclotrisiloxane, octamethyicyciotetrasiioxane, decamethyicyciopentasiioxane, dodecamethylcyclohexasiloxane, or a combination thereof.

13. The method of claim 1, wherein the finishing product includes:
about 0.04% by weight to about 60.5% by weight of an amino functional siloxane, wherein the amino functional siloxanes is comprised of amino-alkoxy dimethylsiloxane, aminoalkoxydimethylpolysiloxane, or a combination thereof;
about 0.02% by weight to about 40% by weight of a drying agent, wherein the drying agent is comprised of isopropyl alcohol, methyl alcohol, 1,2,4-trimethylbenzene, or a combination thereof;
about 0% by weight to about 4.5% by weight of a volatile cyclic siloxane, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof;
about 0% by weight to about 0.5% by weight of a non-ionic surfactant, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, or a combination thereof.

14. A finishing product for application to a surface to create a protective coating upon the surface that enhances the appearance of the surface without the need for buffing or rubbing the surface following application of the finishing product, wherein the finishing product comprises an amino functional siloxane, a drying agent, and a carrier agent.

15. The finishing product of claim 14, wherein the amino functional siloxanes is comprised of amino-alkoxy dimethylsiloxane, aminoalkoxydimethylpolysiloxane, or a combination thereof.

16. The finishing product of claim 14, wherein the finishing product includes from about 0.04% by weight to about 60% by weight of one or more amino functional siloxanes.

17. The finishing product of claim 14, wherein the drying agent is comprised of isopropyl alcohol, methyl alcohol, 1,2,4-trimethylbenzene, or a combination thereof.

18. The finishing product of claim 14, wherein the finishing product includes from about 0.02% by weight to about 40% by weight of drying agent.

19. The finishing product of claim 14, wherein the carrier agent is comprised of water, organic solvent, or a combination thereof.

20. The finishing product of claim 19, wherein the organic solvent is comprised of petroleum distillate, Stoddard solvent, synthetic isoparafinic hydrocarbon, petroleum hydrocarbon, aliphatic hydrocarbon, 2,2-dimethylbutane, or a combination thereof.

21. The finishing product of claim 14, wherein the finishing product further includes from about 0% by weight to about 0.5% by weight of a non-ionic surfactant.

22. The finishing product of claim 21, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof.

23. The finishing product of claim 14, wherein the finishing product further includes from about 0% by weight to about 4.5% by weight of a volatile cyclic siloxane.

24. The finishing product of claim 23, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof.

25. The finishing product of claim 14, wherein the finishing product includes:
about 0.04% by weight to about 60.5% by weight of an amino functional siloxane, wherein the amino functional siloxanes is comprised of amino-alkoxy dimethylsiloxane, aminoalkoxydimethylpolysiloxane, or a combination thereof;
about 0.02% by weight to about 40% by weight of a drying agent, wherein the drying agent is comprised of isopropyl alcohol, methyl alcohol, 1,2,4-trimethylbenzene, or a combination thereof;
about 0% by weight to about 4.5% by weight of a volatile cyclic siloxane, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof;
about 0% by weight to about 0.5% by weight of a non-ionic surfactant, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, or a combination thereof.
